(19) United States
(12) Patent Application Publication
(10) Pub. No.: US 2011/0195765 A1
(43) Pub. Date: Aug. 11, 2011

(54) GAME SYSTEM AND GAME PROGRAM

(75) Inventor: Eisaku Fujimoto, Tokyo (JP)

(73) Assignee: KONAMI DIGITAL ENTERTAINMENT CO., LTD., Tokyo (JP)

(21) Appl. No.: 13/123,658

(22) PCT Filed: Oct. 21, 2009
(86) PCT No.: PCT/JP2009/068129

§ 371 Date: Apr. 11, 2011

(30) Foreign Application Priority Data
Dec. 12, 2008 (JP) 2008-316958

(51) Int. Cl. A63F 9/24; A63F 13/12

(52) U.S. Cl. 463/7

(57) ABSTRACT

There is provided a game system where points are given to a player so as not to make a disparity due to the skill level of the player.

The game system 1 comprises: a provisional point increasing process portion 14ba which increases provisional points each time a period for increasing points has elapsed after the game is started; an operation state information obtaining portion 14bb which obtains operation state information indicating the operation state of the player after the game is started; an operation determination portion 14bc determines, each time a period for confirming operation has elapsed, whether the provisional points should be enabled or not based on the operation state information obtained within the period for confirming operation; and a point enabling process portion 14bd which, when it is determined that the provisional points should be enabled, adds the provisional points increased by the provisional point increasing process portion 14ba to the player points of the player.

### TECHNICAL FIELD

The present invention relates to a game system and a game program capable of giving points the player.

### BACKGROUND ART

There is already well known a game system where points to be used by a player are given to the player based on a game result and/or a game content, and the player can obtain an item to be used during a game or change a value of desired parameter, in exchange of the consumption of the points (for example, patent document 1)

### CITATION LIST

### Patent Literature

PTL 1: 2003-325984

### SUMMARY OF INVENTION

### Problem to be Solved by Invention

However, in conventional game systems, the points are given depending on a game result and a game content. Thereby, the higher the skill level of the player is, the more points are given to the player. Accordingly, it is hard for beginners to accumulate the points comparing to players with high skill level. When the items to be obtained in exchange of the points are, for example, the ones for enhancing ability of the player in the game such as arms and witchcrafts to be used in the game, the beginners are unlikely to obtain those enhancement items, which leads to a problem that a disparity between the beginners and the players with high skill level becomes increasingly bigger.

Then, the present invention aims to provide a game system and a game program for giving the points so as not to make a big disparity due to a skill level of a player.

### Solution to Problem

The game system as one aspect of the present invention solves the above problem by being configured as a game system comprising an operation input portion which accepts operations by a player and a display portion which presents a game image, where a predetermined game is executed in response to the operations by the player, wherein the game system comprises: a player point storage portion which stores player points to be used by the player; a provisional point storage portion which stores provisional points given to the player depending on time the player has spent on the game; a provisional point increasing process portion which, when the game is started, increases the provisional points stored in the provisional point storage portion, each time a period for increasing points for increasing the provisional points has elapsed; an operation state information obtaining portion which obtains, when the game is started, operation state information indicating operation state of the player; an operation determination portion which determines, each time a period for confirming operation in which operation by the player is confirmed has elapsed, whether the provisional points accumulated within the period for confirming operation should be enabled or not, based on the operation state information obtained within the period for confirming operation by the operation state obtaining portion; and a point enabling process portion which adds, when it is determined that the provisional points should be enabled, the provisional points stored in the provisional point storage portion to the player points stored in the player point storage portion.

According to the game system of the present invention, by the provisional point increasing process portion, the provisional points are accumulated depending on the time the player has spent on the game, and by the point enabling process portion, the provisional points are enabled as the player points of the player based on the operation state information obtained by the operation state information obtaining portion. In this way, in the present invention, it is possible to give the points to the player depending on the time the player has spent on the game. Therefore, even if the player is a beginner, in a case that he/she has spent a long time on the game, he/she can obtain the player points in accordance with the utilization time. Thereby, it is possible to provide a game system which gives the player points not so as not to make a big disparity due to the skill level of the player.

In the present invention, as it is determined whether the player points should be finally given to the player or not based on the operation state information, the game system can be configured such that, in a case that the game is started but no operation relating to the game is performed, even if the player has spent a long time on the game, the player points are not given to the player. Thereby, it is possible to avoid obtaining the player points dishonestly. “The operation state information” includes, for example, information indicating the kind and the input order of input operation by the player, information indicating a change of parameter value which changes inevitably in response to the operations by the player in the game, and the like.

The provisional points to be added by the provisional point process portion may be constant number of points, or may be set such that the number of points to be added changes depending on the time the player has spent on the game. The mode of changing the number of points to be added includes for example, a case that the points to be added increase when the player has spent more than predetermined time on the game, and a case that the provisional points to be added increase in proportion to the time the player has spent on the game. It is enough that procedures that the player uses his/her player points are similar to procedures in the well-known game system. For example, the process to be executed in exchange of the player points in the game system includes a process relating to the game content and a process relating to the game progress. The process relating to the game content includes, for example, a process for obtaining an item or information to be used in the game, and, when a competitor is existing in the game, a process for giving the competitor some damage. The process relating to the game progress includes, for example, a process for extending limit time which has been given in order to clear a predetermined stage.

The operation determination may determine whether the present state of the game is a specific state or not, and in a case of not the specific state, when the operation state information satisfies a predetermined criterion, the operation determination portion may determine that the provisional points should be enabled, and in a case of the specific state, even if the operation state information does not satisfy the predetermined criterion, the operation determination portion may determine that the provisional points should be enabled. Thereby, when the state of the game is the specific state, even if the operation state information does not satisfy the predetermined condition, it is possible to accumulate the points. Accordingly, even if the state is a state that the number of operations or the operation content is limited, like, for example, a dying state of player character to be operated by the player, as it is not necessary to satisfy a criterion set appropriately to a normal state, the player can accumulate the points. Namely, even if the game is in the specific state where operations are limited, it is possible to avoid disadvantage caused by the limited operations.

The game system may be configured such that it is determined whether the present state is the specific state or not based on the attribute parameters such as the power parameter or the life parameter of the player character, the score of the player, the state of game itself (such as the number of items held by the player), and the like. The mode “even if the operation state information does not satisfy the predetermined criterion, it is determined that the provisional points should be enabled” includes a case that it is determined the provisional points should be enabled when “the criterion indicating the predetermined criterion is not satisfied” for the specific state is satisfied, and a case that it is always determined the provisional points should be enabled even if the predetermined criterion is not satisfied.

The game system may comprise: a service providing portion which provides the player a service relating to the game depending on consumption amount of the player points; and a point consumption portion which requires the service providing portion the service in response to the operation by the player, and subtracts points corresponding to the service from the player points stored in the player point storage portion. Thereby, the player can enjoy the service provided by the service providing portion in exchange of the consumption of the player points. The service includes for example, selling game items, providing game capture information and the like.

the service providing portion may provide to the player, a service of selling an item to be used in the game depending on the points consumed by the player, and the point consumption portion may require to the service providing portion, to sell the item specified by the player, and subtracts the points corresponding an item specified by the player from the player points. Thereby, it is possible to fortify the items to be used during the game, by using points taken during the game. The number of points corresponding to each service may be held by the service providing portion, or may be held by the point consumption portion.

The display portion, the player point storage portion, the provisional point storage portion, the provisional pint increasing process portion, the operation state obtaining portion, the operation determination portion, the point enabling process portion, and the point consumption portion may be provided to a game machine, and the service providing portion may be provided to a server capable of connecting with the game machine through a communication line to provide an item selling site to the game machine, the point consumption portion may access, when a server connection operation is performed by the player during the game, the item selling site which the service providing portion provides to require the item selling site to sell the item selected by the player, and may subtract the points corresponding to the selected points from the player points in the player point storage portion.

Thereby, it is possible for plural game machines to share the service providing portion of the server. As the management of service providing portion is unified by the server, even if there are plural game machines, it is enough that the update processes such as addition, deletion, and change of the items to be sold, are executed only to the service providing portion of the server. Moreover, for example, the game system may be configured such that the number of points to be consumed is different depending on the game machine.

The game system may further comprise a privilege point giving portion which determines, at a predetermined moment in the game, whether or not a predetermined process in the game has been completed within a criterion period, and when an affirmative determination is obtained, further adds a predetermined number of points as privilege points to the player points. Thereby, for the player who has such a high skill level that difficult processes are completed in very short time, it is possible to give the player some privilege. Accordingly, in the game system where the more time the player spent on the game, the more points are given to the player, it is possible to give significance also to an early end of the game.

A game program as one aspect of the present invention solves the above problems by being configured as a game program which functions a computer of a game machine comprising an operation input portion which accepts operations by a player, a display portion which presents a game image, a player point storage portion which stores player points to be used by the player and a provisional point storage portion which stores provisional points given to the player depending on time the player has spent on the game, where a predetermined game is executed in response to the operations by the player, wherein the game program functions the computer as a provisional point increasing process portion which, when the game is started, increases the provisional points stored in the provisional point storage portion, each time a period for increasing points for increasing the provisional points has elapsed; an operation state information obtaining portion which obtains, when the game is started, operation state information indicating operation state of the player; an operation determination portion which determines, each time a period for confirming operation in which operation by the player is confirmed has elapsed, whether the provisional points accumulated within the period for confirming operation should be enabled or not, based on the operation state information obtained within the period for confirming operation by the operation state obtaining portion; and a point enabling process portion which adds, when it is determined that the provisional points should be enabled, the provisional points stored in the provisional point storage portion to the player points stored in the player point storage portion. If the computer is controlled according to this game program of the present invention, the game system of the present invention is realized.

### Effects of the Invention

As mentioned above, according to the present invention, when the game is started, the provisional points are increased each time the period for increasing points has elapsed, and on the other hand, the operation state information indicating the operation state of the player is obtained. When it is determined based on the operation state information that the player is performing operations relating to the game, the provisional points are enabled as the player points. Thereby, it is possible to provide a game system and a game program where the points are given to the player so as not to make a big disparity due to the player's skill level.

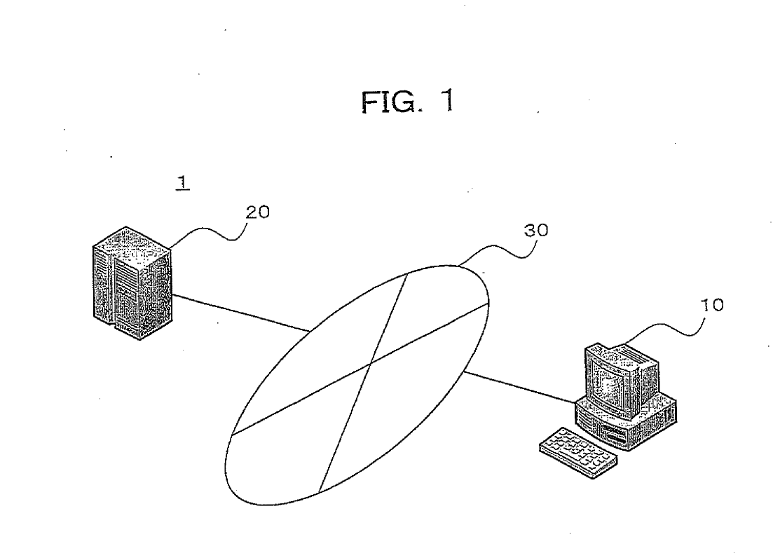

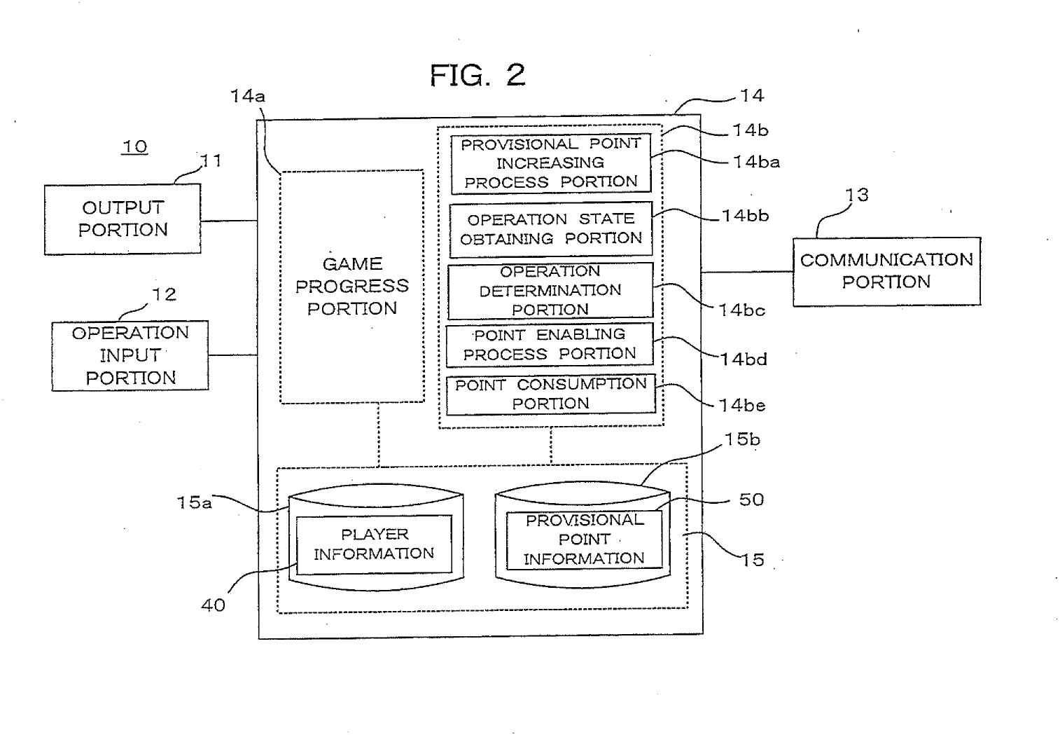

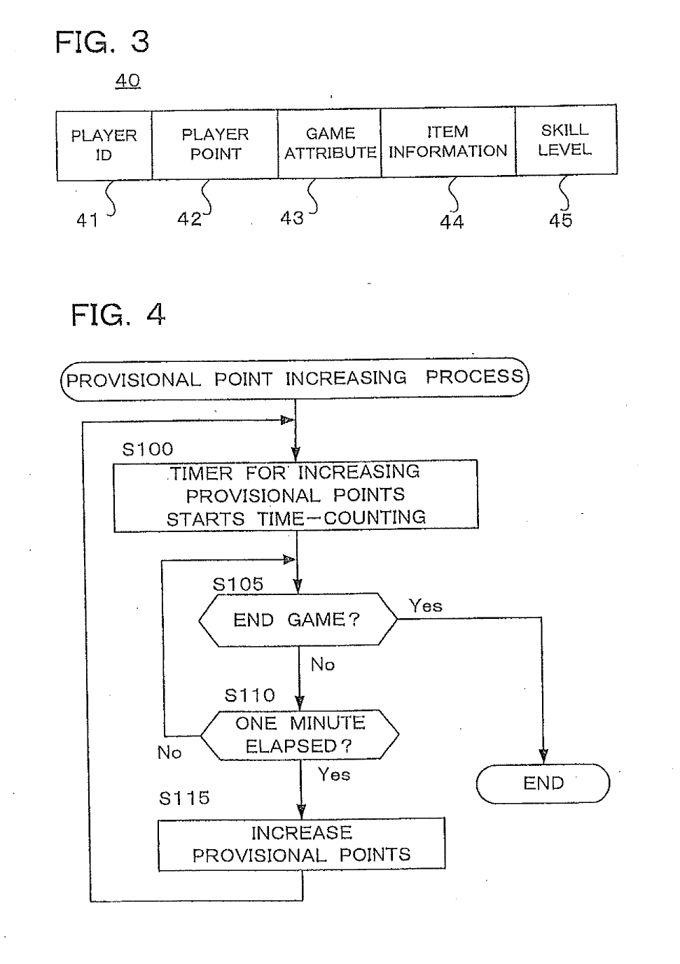

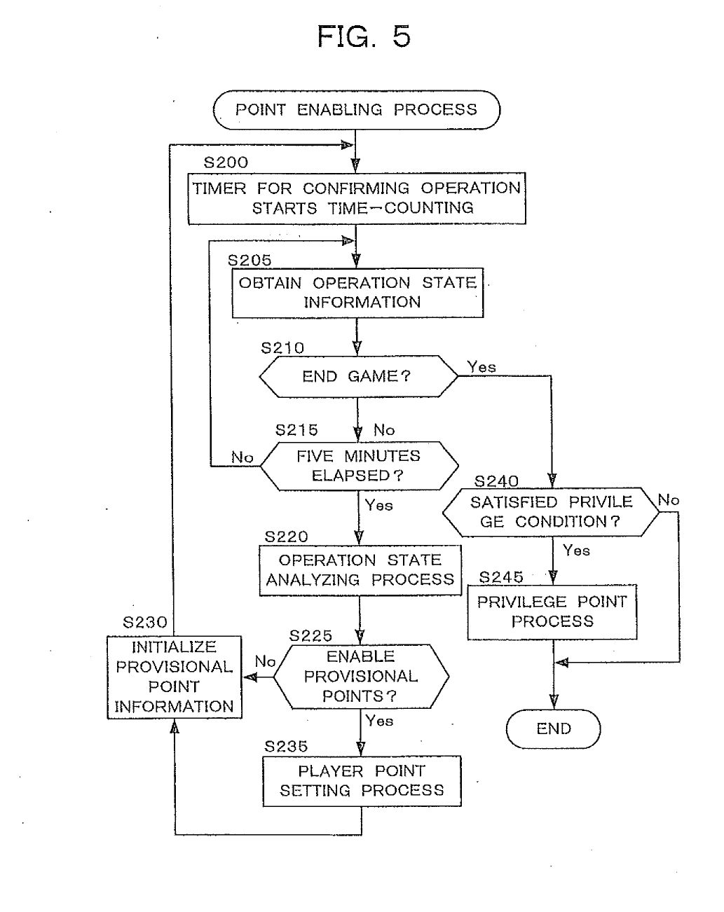

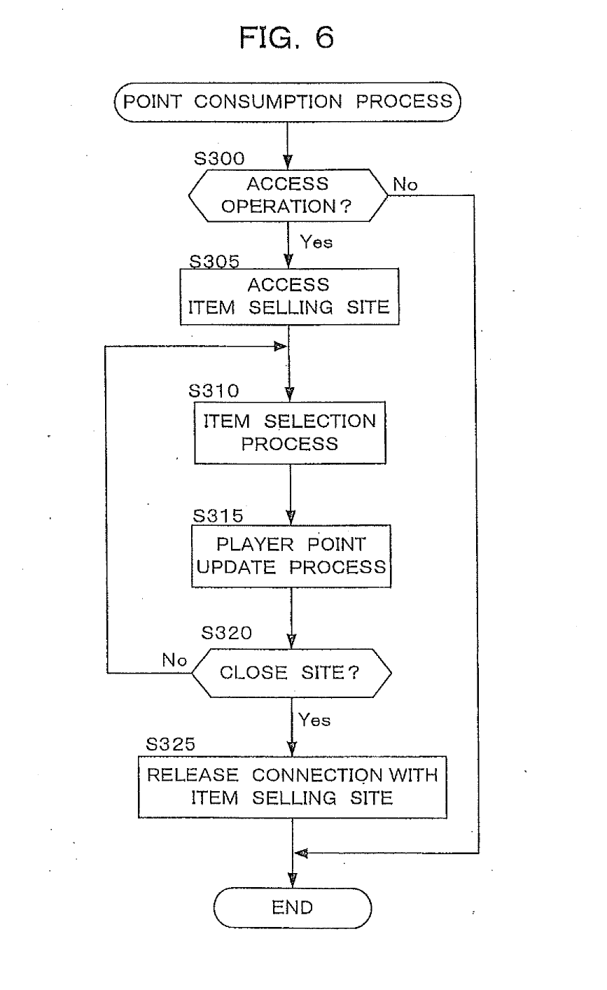

### BRIEF DESCRIPTION OF DRAWINGS

[FIG. 1] A diagram showing an example of configuration of the game system of the present invention.

[FIG. 2] A diagram showing an outline of hardware configuration of the game machine shown in FIG. 1.

[FIG. 3] A diagram showing a data construction of player information.

[FIG. 4] A flowchart showing a flow of processes executed in a provisional point increasing process.

[FIG. 5] A flowchart showing a flow of processes executed in a point enabling process.

[FIG. 6] A flowchart showing a flow of processes executed in a point consumption process.

### EMBODIMENT FOR EXECUTING INVENTION

FIG. 1 is a diagram showing an example of configuration of a game system I of the present invention. In the game system 1, a game machine 10 where a predetermined game is executed by a player and a service providing sever 20 are connected with each other through a network 30 by a communication line. The communication line may be a dedicated line or a public line, and may be wired or wireless. The service providing server 20 provides in response to a request from the game machine 10, an item selling site providing a sale of items to be used in the game. The configuration of the service providing server 20 may be a well-known server which provides the item selling site to the game machine as a client.

In the game system 1, when the game starts at the game machine 10, points are calculated depending on time the player has spent on the game and the points are given to the player. The player can obtain in exchange of the consumption of the given points, his/her desired item from the item selling site which the service providing server 20 provides. In the present invention, it does not matter which kind of the game executed at the game machine 10 is, as long as the game progresses in response to operations by a player. For example, the game may be executed as a network type game which is executed with the other game machine through the network 10, or may be executed as a stand-alone type game which is executed within a single game machine 10.

The outline of hardware configuration of the game machine 10 will be described using FIG. 2. The game machine 10 comprises an output portion 11 including a monitor as a display portion which displays a game image, a speaker which outputs a sound and the like, an operation input portion 12 accepting the operations by the player, a communication portion 13 for communicating with the service providing server 20, and a game control unit 14.

The game control unit 14 comprises a CPU and a memory area 15 necessary for the CPU's operation, and by operating according to a game program stored in the memory area 15, the game control unit 14 mainly functions as a game progress portion 14a which controls a progress of the game, and a point control portion 14b which controls processes for the points which are given to the player. The point control portion 14b includes a provisional point increasing process portion 14ba, an operation state obtaining portion 14bb, an operation determination portion 14bc, a point enabling process portion 14bd, and a point consumption portion 14be. Each of the portions will be described later. In the game control unit 14, various kinds of timers for counting predetermined time are also provided.

Information stored in the memory area 15 will be described. The memory area 15 includes a player information storage portion 15a and a provisional point storage portion 15b. In the player information storage portion 15a, player information 40 having information of each player is stored. In the provisional point storage portion 15b, provisional point information 50 is stored, the provisional point information 50 indicating provisional points given to the player which are not yet enabled as player point 42.

The player information 40, as shown in FIG. 3, a player ID 41 for identifying the player is correlated to the following information: a player point 42 indicating the number of points which were given to the player and capable of being used, a game attribute 43 including various kinds of parameters each of which indicates an attribute of the player in the game, an item information 44 which indicates the kind and the number of items the player is holding, and a skill level 45 of the player determined based on past game results and past game contents. It does not matter which kind of the item being indicated by the item information 44, as long as the item is used in the game. For example, in a case of a battle game, the items could be witchcrafts and arms, and in a case of a dress-up game, the items could be dresses and accessories.

In the present invention, firstly, the provisional points are calculated depending on the time the player has spent on the game. A provisional point increasing process for calculating the provisional points will be described. The provisional point increasing process is executed in the game machine 10. The processes executed in the provisional point increasing process will be described by following a flow chart shown in FIG. 4. The provisional point increasing process is controlled by the game control unit 14 as the provisional point increasing process portion 14ba. In the provisional point increasing process, when the game is started, firstly, the provisional point information 50 in the provisional point storage portion 15b is initialized, and each time one minute, that is the period for increasing provisional points, has elapsed, five of provisional points are added to the provisional point information 50.

Firstly, at step S100, a timer for increasing provisional points starts time-counting. The timer for increasing provisional points of the present embodiment is a timer which counts one minute as the period for increasing provisional points. Subsequently, at step S105, it is determined whether the game should be ended or not. In the present embodiment, for example, in a case the game reaches a predetermined section, or a game end operation is performed by the player, it is determined that the game should be ended. When an affirmative determination is obtained at step S105, the provisional point increasing process is ended, and a negative determination is obtained, the process goes to step S110.

At step S110, it is determined whether or not the timer for increasing provisional points has counted one minute. When a negative determination is obtained at step S110, the process goes back to step S105, and an affirmative determination is obtained, the process goes to step S115. At step S115, the provisional points are increased. That is, five points are added to the provisional point information 50. After the addition is executed, the process goes back to step S100, and subsequently, the process with respect to the next period for increasing provisional points is executed.

On the other hand, in the game machine 10, when the game is started, together with the provisional point increasing process, a point enabling process is also executed. The point enabling process is for enabling as the player point 42, the provisional points accumulated by the provisional point increasing process. In the present embodiment, on condition that the player is performing operations for the game, the provisional points are enabled, that is, set as the player point 42. The point enabling process is controlled by the point control portion 14. The processes executed in the point enabling process will be described by following FIG. 5,

Firstly, at step S200, a timer for confirming operation starts time-counting. The timer for confirming operation is a timer for counting a period for confirming operation (five minutes in the present embodiment). The period for confirming operation is a unit of period for confirming whether or not the player is performing operations for the game. Subsequently, at step S205, operation state information is obtained, the operation state information indicating an operation state of the player. Thereby, the point control portion 14b functions as the operation state obtaining portion 14bb. As the operation information, for example, key information (including the kind and the input order of input keys), value information of parameters changeable in the game and the like can be used. Next, the process goes to step S210 to determine whether the game should be ended or not. As mentioned above, in a case the game reaches a predetermined section set in the game, or a game end operation is performed by the player, it is determined that the game should be ended. When an affirmative determination is obtained at step S210, the process goes to step S240, and when a negative determination is obtained, the process goes to step S215.

At step S215, it is determined whether or not the timer for confirming operation counts five minutes. When a negative determination is obtained at step S215, the process goes back to step S205 to continue obtaining the operation state information, and when an affirmative determination is obtained, the process goes to step S220. At step S220, an operation state analyzing process is executed. Thereby, the point control portion 14 functions as the operation determination portion 14bc. In the operation state analyzing process, based on the operation state information obtained in the period for confirming operation, an analysis for determining whether the player is performing operations for the game to the game machine 10, is executed. For example, standard key information about keys which could be used in the game has been set in advance, and the key information about input keys obtained in the period for confirming operation is checked against the standard key information, and the rate of the key operations by the player to the standard key information is calculated.

Next, the process goes to step S225, it is determined, based on the analysis result in step S220, whether or not the provisional points stored in the provisional point information 50 should be enabled or not. In the above case, when the calculated rate reaches a predetermined criterion value, it is determined that the player is playing the game, and when the calculated rate does not reach the criterion value, it is determined that the player is not playing the game. In a case that it is determined that the player is not playing the game, the provisional points are not enabled, and after initializing the provisional point information 50 at step S230, the process goes back to step S200. In a case that it is determined at step S225, that the player is playing the game, the process goes to step S235 to execute a player point setting process. Thereby, the point control portion 14b functions as the point enabling process portion 14bd. In the player point setting process, as a process for enabling the provisional points, the provisional points in the provisional point information 50 are added to the player point 40 corresponding to the player. After the player point setting process, the provisional point information 50 is initialized at step S230 and the process goes back to step S200.

On the other hand, at step S240, it is determined whether a privilege condition has been satisfied in the game or not. The privilege condition is a condition for further increasing the player point 42 set depending on the time the player has spent on the game. For example, it is determined that the privilege condition has been satisfied, in a case that a predetermined stage was cleared within a predetermined time in the game, or in a case that a predetermined item was obtained. When a negative determination is obtained at step S240, the point enabling process is just ended, and when an affirmative determination is obtained, the process goes to step S245. At step S245, a privilege point process is executed. In the privilege point process, for an example of privilege, the same number of points as the player point 42 set from game start to game end may be further added to the player point 42. Thereby, the point control portion 14b functions as a privilege point giving portion.

By accessing during the game, an item selling site provided by the service providing server 20, the player can buy his/her desired item in exchange of the consumption of the player point 42 held by the player. A point consumption process for obtaining an item will be described by following a flow chart shown in FIG. 6. The point consumption process is controlled by the point control portion 14b as the point consumption portion 14be.

First, at step S300, it is determined whether a server connection operation for accessing the service providing server 20 has been performed or not. When a negative determination is obtained at step S300, the point consumption process is ended, and when an affirmative determination is obtained, the process goes to step S305 to access the item selling site provided by the service providing server 20. After accessing the item selling site, the process goes to step S310 to execute the item selection process. In the item selection process, for example, an item selection image, where various kinds of items to be sold can be selected by the player, is displayed in the display portion, and the player can select his/her desired item. Each of the items to be provided at the item selling site is correlated to the points depending on the item.

The item information 40 with respect to the selected item is, for example, added to the item information 44 of the player information as the item held by the player. Subsequently, the process goes to step S315 to execute a player point update process. In the player point update process, the points corresponding to the selected item are subtracted from the player point 42. Subsequently, at step S320, it is determined whether the item selling site should be closed or not. In a case that a predetermined site close operation is performed by the player, it is determined that the item selling site should be closed. When an affirmative determination is obtained at step S325, the process goes to step S325 to release the connection with the item selling site and end the point consumption process. When a negative determination is obtained at step S320, the process goes back to step S310 to continue the processes in the item selling site.

The present invention is not limited to the above embodiment and can be executed in various kinds of embodiments. For example, the game system may be designed such that, as the criterion value to be referred to at the moment of the determination of step S225, a criterion value for normal mode and a criterion value for specific mode are prepared in advance, and in a case that a player character which is an operation object of the player is in the specific mode (for example, a dying state), the criterion value for the specific mode is referred to. Alternatively, in a case of the specific mode, the game system may be designed such that the points are accumulated without relation to the criterion value. It may be determined whether the present mode is the specific mode or not, by referring to, for example, attribute parameters of the player character such as a power parameter and a life parameter

The service providing server 10 and the game machine 20 may be connected with each other directly, not through the network 30. The service providing portion of the present invention does not have to be independent of the game machine 10, and may be provided in the game machine 10 as a portion dedicated to the game machine 10. The number of points to be added to the provisional point information 50 in the provisional point increasing process, is not necessary to be constant. For example, the number may be designed so as to increase depending on the time the player has spent on the game. In this case, the game system may be designed such that a timer for counting the utilization time is prepared for counting the time the player has spent on the game from the game start, and between step S110 and step S115, a process is inserted for determining the number of points to be added depending on the time the player has spent on the game.

1. A game system comprising an operation input portion which accepts operations by a player and a display portion which presents a game image, where a predetermined game is executed in response to the operations by the player, wherein
the game system comprises:
a player point storage portion which stores player points to be used by the player;
a provisional point storage portion which stores provisional points given to the player depending on time the player has spent on the game;
a provisional point increasing process portion which, when the game is started, increases the provisional points stored in the provisional point storage portion, each time a period for increasing points for increasing the provisional points has elapsed;
an operation state information obtaining portion which obtains, when the game is started, operation state information indicating operation state of the player;
an operation determination portion which determines, each time a period for confirming operation in which operation by the player is confirmed has elapsed, whether the provisional points accumulated within the period for confirming operation should be enabled or not, based on the operation state information obtained within the period for confirming operation by the operation state obtaining portion; and
a point enabling process portion which adds, when it is determined that the provisional points should be enabled, the provisional points stored in the provisional point storage portion to the player points stored in the player point storage portion.

2. The game system of claim 1, wherein
the operation determination portion determines whether the present state of the game is a specific state or not, and in a case of not the specific state, when the operation state information satisfies a predetermined criterion, the operation determination portion determines that the provisional points should be enabled, and in a case of the specific state, even if the operation state information does not satisfy the predetermined criterion, the operation determination portion determines that the provisional points should be enabled.

3. The game system of claim 1 further comprising:
a service providing portion which provides the player a service relating to the game depending on consumption amount of the player points; and
a point consumption portion which requires the service providing portion the service in response to the operation by the player, and subtracts points corresponding to the service from the player points stored in the player point storage portion.

4. The game system of claim 3, wherein
the service providing portion provides to the player, a service of selling an item to be used in the game depending on the points consumed by the player, and
the point consumption portion requires to the service providing portion, to sell the item specified by the player, and subtracts the points corresponding an item specified by the player from the player points.

5. The game system of claim 4, wherein
the display portion, the player point storage portion, the provisional point storage portion, the provisional pint increasing process portion, the operation state obtaining portion, the operation determination portion, the point enabling process portion, and the point consumption portion are provided to a game machine, and
the service providing portion is provided to a server capable of connecting with the game machine through a communication line to provide an item selling site to the game machine,
the point consumption portion accesses, when a server connection operation is performed by the player during the game, the item selling site which the service providing portion provides to require the item selling site to sell the item selected by the player, and subtracts the points corresponding to the selected points from the player points in the player point storage portion.

6. The game system of claim 1
comprising a privilege point giving portion which determines, at a predetermined moment in the game, whether or not a predetermined process in the game has been completed within a criterion period, and when an affirmative determination is obtained, further adds a predetermined number of points as privilege points to the player points.

7. A storage medium storing a game program which functions a computer of a game machine comprising an operation input portion which accepts operations by a player, a display portion which presents a game image, a player point storage portion which stores player points to be used by the player and a provisional point storage portion which stores provisional points given to the player depending on time the player has spent on the game, where a predetermined game is executed in response to the operations by the player, wherein
the game program functions the computer as
a provisional point increasing process portion which, when the game is started, increases the provisional points stored in the provisional point storage portion, each time a period for increasing points for increasing the provisional points has elapsed;
an operation state information obtaining portion which obtains, when the game is started, operation state information indicating operation state of the player;
an operation determination portion which determines, each time a period for confirming operation in which operation by the player is confirmed has elapsed, whether the provisional points accumulated within the period for confirming operation should be enabled or not, based on the operation state information obtained within the period for confirming operation by the operation state obtaining portion; and
a point enabling process portion which adds, when it is determined that the provisional points should be enabled, the provisional points stored in the provisional point storage portion to the player points stored in the player point storage portion.
